(19) United States
(12) Patent Application Publication
(10) Pub. No.: US 2024/0401403 A1
(43) Pub. Date: Dec. 5, 2024

(54) HIDDEN COVERING FOR TWO PANEL FENESTRATION UNIT

(71) Applicant: Pella Corporation, Pella, IA (US)

(72) Inventors: Brian L. Kolb, Pella, IA (US); Evan R. Vande Haar, Pella, IA (US)

(73) Assignee: Pella Corporation, Pella, IA (US)

(21) Appl. No.: 18/524,561

(22) Filed: Nov. 30, 2023

Related U.S. Application Data
(60) Provisional application No. 63/470,472, filed on Jun. 2, 2023.

(51) Int. Cl. E06B 9/262; E06B 9/52

(52) U.S. Cl. CPC E06B 9/262; E06B 9/52; E06B 2009/2625; E06B 2009/527

(57) ABSTRACT

A fenestration unit may include a frame, a first panel to selectively allow and limit ingress and egress through an opening defined by the fenestration unit, a second panel, and a screen assembly. The screen assembly may include a pleated screen, a screen frame, and a control member. The pleated screen may include a first lateral end and a second lateral end and may be operable to extend across the opening when the screen assembly is in a deployed configuration and operable to allow ingress and egress through the opening in a stowed configuration. The pleated screen may be substantially flatter in the deployed configuration and may be folded into pleats in the stowed configuration. The screen frame may be coupled to the first lateral end of the pleated screen and may engage with and translate relative to the frame and across the opening. The control member may be coupled to the second lateral end of the pleated screen and may be slidingly engaged with the screen frame.

### CROSS RELATED APPLICATION

This application claims priority to U.S. Provisional Patent Application No. 63/470,472, entitled “Hidden Covering for Two Panel Fenestration Unit”, filed Jun. 2, 2023, the contents of which are hereby incorporated by reference in its entirety.

### TECHNICAL FIELD

The present description relates generally to fenestration assemblies, systems and methods. Specifically, the description relates to fenestration assemblies including screen assemblies.

### BACKGROUND

Sliding fenestration assemblies generally include two panels. One panel is often a fixed panel and one is a venting panel allowing ingress and egress. Sliding fenestration assemblies often include a screen mounted to a secondary sliding panel selectively positionable relative to the fixed and venting panels. The screen is able to keep out insects or other pests while still permitting air flow through the fenestration assembly when the venting panel is in the open position. Over time the screen can be continuously exposed to the elements, leading to an accumulation of airborne detritus on the screen, further obscuring the view.

What is needed are screen systems that are simple to use, do not obscure the view through the glass panels, and are aesthetically pleasing when in use and when not in use.

### SUMMARY

Various disclosed concepts relate to a screen assembly, a fenestration unit including a screen assembly, and associated methods.

According to one example (“Example 1”), a screen assembly is provided for a fenestration unit having a fenestration frame, a first panel, and a second panel, the first panel being operable to selectively allow and limit ingress and egress through an opening defined by the fenestration unit, the screen assembly including a pleated screen operable to extend across the opening of the fenestration unit when the screen assembly is positioned in a deployed configuration and operable to be positioned to allow ingress and egress through the opening of the fenestration unit when the screen assembly is in a stowed configuration, the pleated screen including a first lateral end and a second lateral end opposite the first lateral end, wherein the pleated screen is substantially flatter when the screen assembly is in the deployed configuration and is folded into pleats when the screen assembly is in the stowed configuration; a screen frame coupled to the first lateral end of the pleated screen, the screen frame operable to be engaged with and translate relative to the fenestration frame and across the opening of the fenestration unit; and a control member coupled to the second lateral end of the pleated screen, the control member slidingly engaged with the screen frame.

According to another example (“Example 2”), further to Example 1, the screen frame is operable to slide laterally within the frame of the fenestration unit.

According to another example (“Example 3”), further to Example 1, the screen frame includes an upper rail, a lower rail, a first stile extending between the upper rail and a lower rail at a first lateral end of the upper and lower rails, and a second stile extending between the upper rail and the lower rail at a second lateral end of the upper and lower rails.

According to another example (“Example 4”), further to Example 3, the first lateral end of the screen is coupled to the first stile.

According to another example (“Example 5”), further to Example 3, each of the upper rail, lower rail, first stile, and second stile including channels within which an outer perimeter of the pleated screen is positioned when the screen assembly is in the deployed configuration.

According to another example (“Example 6”), further to Example 3, the first stile includes a channel within which the pleated screen is at least partially concealed when the screen assembly is in a stowed configuration.

According to another example (“Example 7”), further to Example 6, the control member is operable to be positioned at least partially within the channel of the first stile when the screen assembly is in a stowed configuration.

According to another example (“Example 8”), further to Example 1, the pleated screen includes vertical pleats such that the pleated screen deploys in a horizontal direction.

According to another example (“Example 9”), further to Example 1, the pleated screen is operable to be concealed by the screen frame and the control member when the screen assembly is in the stowed configuration such that the pleated screen is not visible from an interior side or an exterior side of the fenestration unit.

According to another example (“Example 10”), further to Example 1, the control member is movable relative to the screen frame.

According to another example (“Example 11”), further to Example 1, the control member includes a deployment member operable to engage with a corresponding feature of the fenestration unit, wherein the deployment member restricts movement of the control member relative to the fenestration unit when the screen frame is translated relative to the fenestration unit.

According to another example (“Example 12”), further to Example 1, the screen frame includes a channel along which the control member is operable to translate relative to the screen frame.

According to another example (“Example 13”), further to Example 12, the control member includes a roller operable to roll along at least a portion of the channel of the screen frame.

According to another example (“Example 14”), further to Example 1, the screen assembly is a retrofit kit.

According to an example (“Example 15”), a fenestration unit includes a fenestration frame including a head having a first lateral end and a second lateral end, a sill having a first lateral end and a second lateral end, a first jamb extending between the header and the sill at the first lateral sides of the header and sill, and a second jamb extending between the header and sill at the second lateral sides of the head and sill; a first panel coupled to the fenestration frame, the first panel being operable to selectively allow and limit ingress and egress through an opening defined by the fenestration unit; a second panel coupled to the fenestration frame; and a screen assembly operable to be transitioned between a deployed configuration to limit ingress and egress through the fenestration unit while allowing air to flow through the opening of the fenestration unit when the first panel is in an open configuration and a stowed configuration to allow ingress and egress through the opening of the fenestration unit when the second panel is in the open configuration, wherein, when the screen assembly is positioned in the stowed configuration, visibility through the second panel is not obscured, the screen assembly including: a pleated screen operable to extend across the opening of the fenestration unit when the screen assembly is positioned in a deployed configuration and operable to be positioned to allow ingress and egress through the opening of the fenestration unit when the screen assembly is in a stowed configuration, the pleated screen including a first lateral end and a second lateral end opposite the first lateral end, wherein the pleated screen is substantially flatter when the screen assembly is in the deployed configuration and is folded into pleats when in the screen assembly is in the stowed configuration; a screen frame coupled to the first lateral end of the pleated screen, the screen frame slidingly coupled to the fenestration frame and operable to translate relative to along at least a portion of the fenestration frame; and a control member coupled to the second lateral end of the pleated screen, the control member operable to translate relative to the screen assembly and to remain positioned proximate the second panel when the screen fame is translated relative to the fenestration frame.

According to another example (“Example 16”), further to Example 15, the screen frame includes an upper rail, a lower rail, a first stile extending between the upper rail and a lower rail at a first lateral end of the upper and lower rails, and a second stile extending between the upper rail and the lower rail at a second lateral end of the upper and lower rails, wherein the first stile defines a first channel within which a portion of the pleated screen is housed when the screen assembly is in the stowed configuration.

According to another example (“Example 17”), further to Example 16, the second stile defines a second channel, and wherein the control member is operable to be substantially contained within the second channel of the second stile when the screen assembly is in the deployed configuration.

According to another example (“Example 18”), further to Example 16, the pleated screen includes a first longitudinal end and a second longitudinal end, wherein the upper rail of the screen frame includes a third channel within which the first longitudinal end of the pleated screen is positioned and the lower rail of the screen frame includes a fourth channel within which the second longitudinal end of the pleated screen is positioned.

According to another example (“Example 19”), further to Example 15, the pleated screen includes vertical pleats such that the pleated screen deploys in a horizontal direction.

According to another example (“Example 20”), further to Example 15, the pleated screen is operable to be concealed by the sliding member and the control member when the screen assembly is in the stowed configuration such that the pleated screen is not visible from an interior side or an exterior side of the fenestration unit.

According to another example (“Example 21”), further to Example 15, the fenestration unit includes a ramp positioned on the screen frame and operable to be contacted by the control bar to translate the control bar upward.

According to another example (“Example 22”), further to Example 21, the ramp is operable to translate a deployment member of the control bar out of a channel of a bracket to disengage the deployment member from the channel of the bracket.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is a fenestration unit from an exterior side with a screen assembly in a stowed configuration, according to some embodiments of the disclosure;

FIG. 1B is the fenestration unit of FIG. 1A from an exterior side with the screen assembly in a deployed configuration, according to some embodiments of the disclosure;

FIG. 1C is the fenestration unit of FIGS. 1A and 1B from an exterior side with the screen assembly in the stored configuration, according to some embodiments of the disclosure;

FIG. 1D is the fenestration unit of FIGS. 1A-1C from a perspective view, according to some embodiments of the disclosure;

FIG. 2 is a screen assembly, according to some embodiments of the disclosure;

FIG. 3A is a section view of a screen assembly illustrating a screen at least partially stowed, according to some embodiments of the disclosure;

FIG. 3B is a perspective, section view of a screen assembly illustrating a screen at least partially stowed, according to some embodiments of the disclosure;

FIG. 4 is a perspective view of a screen assembly with a screen frame and a control member, according to some embodiments of the disclosure;

FIG. 5 is a front view of a bracket operable to engage at least a portion of the screen assembly, according to some embodiments of the disclosure;

FIG. 6 is a section view of a fenestration unit illustrating a screen assembly engaging a bracket positioned on another panel of the fenestration unit, according to some embodiments of the disclosure;

FIGS. 7 and 8 are perspective views of the bracket engaging a portion of the screen assembly, according to some embodiments of the disclosure

FIG. 9 is a front view of a bracket operable to engage at least a portion of the screen assembly, according to some embodiments of the disclosure; and

FIG. 10 is a cord routing system for the screen assembly 100, according to some embodiments of the disclosure.

While the inventive concepts addressed herein are amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

### Definitions and Terminology

This disclosure is not meant to be read in a restrictive manner. For example, the terminology used in the application should be read broadly in the context of the meaning those in the field would attribute such terminology. Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

Certain terminology is used herein for convenience only. For example, words such as “top”, “bottom”, “upper,” “lower,” “left,” “right,” “horizontal,” “vertical,” “upward,” and “downward” merely describe the configuration shown in the figures or the orientation of a part in the installed position. Indeed, the referenced components may be oriented in any direction. Similarly, throughout this disclosure, where a process or method is shown or described, the method may be performed in any order or simultaneously, unless it is clear from the context that the method depends on certain actions being performed first.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### Description of Various Embodiments

Some inventive concepts provided by this disclosure relate to integrated screen features, enhanced bug sealing between sashes, and others. These inventive concepts are examples only, and further inventive concepts, as well as their advantages and associated functions will be appreciated from this disclosure.

In some examples, fenestration units are provided that allow a user to view through the glazing panels of a fenestration unit without the obstruction of a screen or the like (e.g., when the screen is in the stowed configuration), while having the ability to open the fenestration unit and have a screen to prevent debris and pests from entering through the fenestration unit. Furthermore, the disclosed device provides the advantage of a retractable screen that does not have a mechanism that biases the retractable screen toward a closed position. In some examples, the required force to slide the retractable screen may be maintained at a minimal level because the screen assembly does not exert a force for rehousing or recoiling the screen. Another advantage includes a tighter fit between the screen and the frame during use, thus minimizing the space through which debris and pests may enter through the fenestration unit. Another advantage includes a screen (e.g., a pleated screen) that is released in a relatively flat configuration so as to minimize obstruction of the view due to pleating. Another advantage includes a screen assembly that may be installed on a new fenestration unit or that may be retrofitted onto an existing fenestration unit.

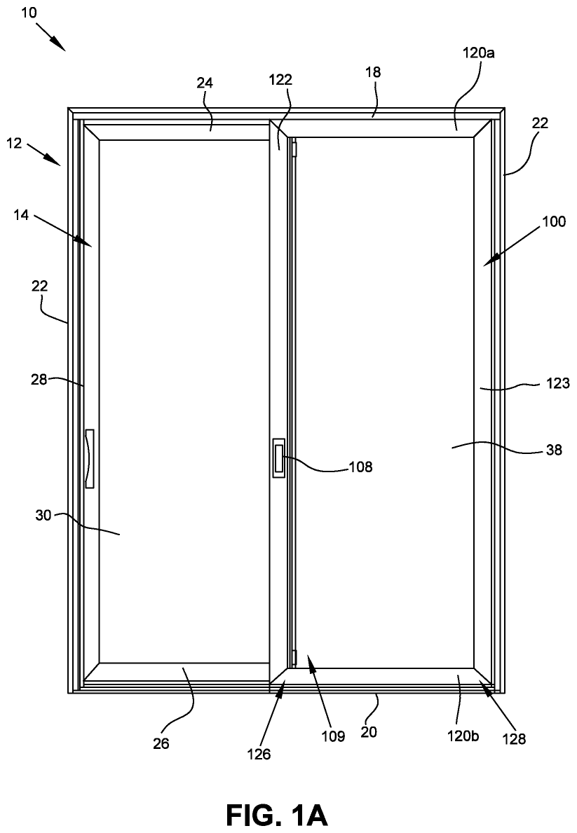

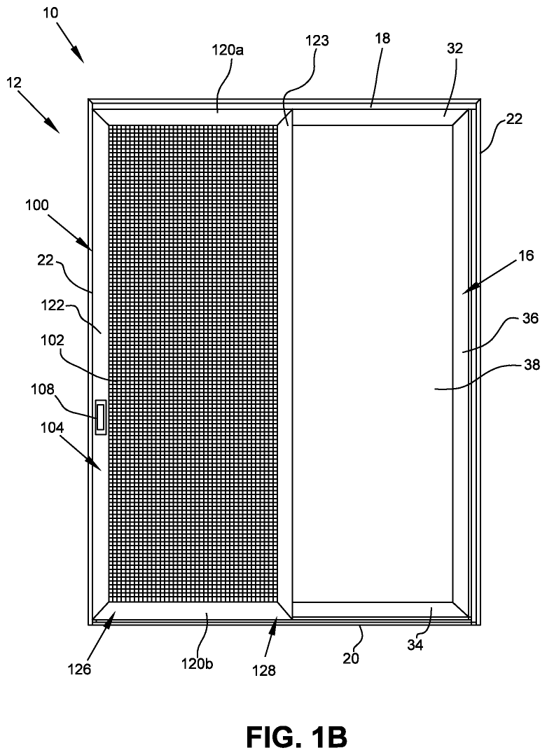

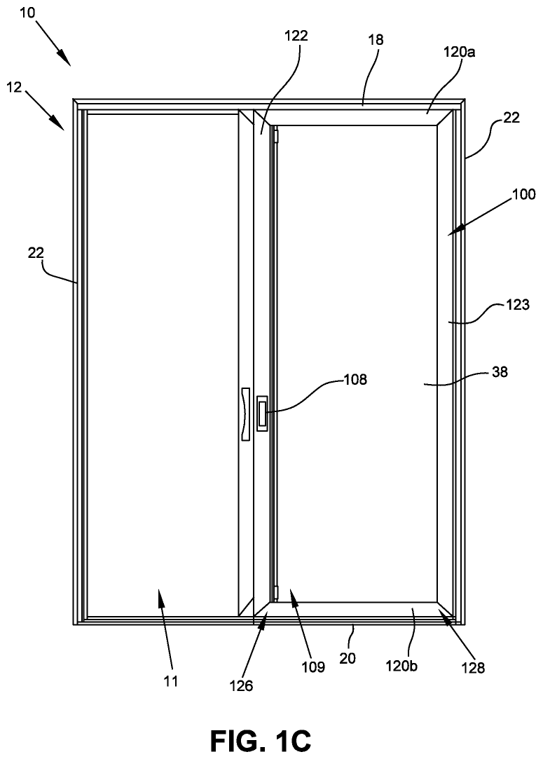

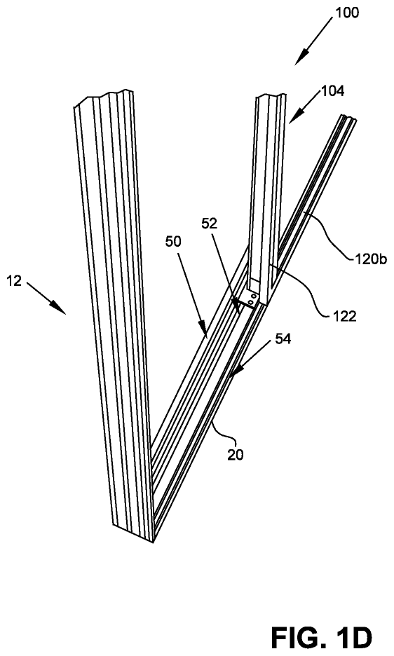

FIGS. 1A and 1B are front views of an exterior-facing side of a fenestration unit 10, according to some embodiments of this disclosure. By “exterior-facing side” it is meant the side of the fenestration unit 10 that typically faces toward an exterior of a building structure into which the fenestration unit 10 is installed. In some embodiments, the fenestration unit 10 may be a two-panel fenestration unit, which generally refers to a fenestration unit with two panels in which at least one of the panels is operable to be positioned in an open configuration and a closed configuration (also described as a vent panel). The second panel (e.g., second panel 16) may be either repositionable between an open and a closed configuration or may be fixedly positioned with the fenestration unit 10 (e.g., a vent panel or what is termed a fixed panel). The first panel (e.g., the first panel 14) may either be a sliding panel or a hinged panel. As shown in FIG. 1A and 1B, the fenestration unit 10 is a sliding door fenestration unit that includes a frame 12, a first panel 14 (see FIG. 1A, hidden by a screen assembly in 1B), and a second panel 16 (see FIG. 1B, hidden by a screen assembly in 1A). In some embodiments, at least one of the first panel 14 or second panel 16 is a sliding panel (e.g., glass sliding panel) such that the fenestration unit 10 is a sliding door. In some embodiments, the first panel 14 is a sliding panel and the second panel 16 is a fixed panel (e.g., a fixed glass panel). In other embodiments both the first and second panels 14, 16 are both sliding panels. In yet other embodiments, one or both of the first and second panels 14, 16 are hinged panels. The frame 12 may include a first portion, or head 18, a second portion, or sill 20, and jambs 22. Together, the head 18, the sill 20, and the jambs 22 surround and support the first panel 14 and the second panel 16. The first panel 14 can include an upper rail 24, a lower rail 26, stiles 28, and a glazing 30. Together, the upper rail 24, the lower rail 26, and the stiles 28 surround and support the glazing 30. The second panel 16 can include an upper rail 32, a lower rail 34, stiles 36, and glazing 38 (see, e.g., FIG. 1B). Together, the upper rail 32, the lower rail 34, and the stiles 36 surround and support the glazing 38. In some embodiments, the frame 12 includes pockets 50, 52 within which the first and/or second panels 14, 16 ride. The first and/or second panels 14, 16 may be operable to slide horizontally relative to the frame 12.

As shown in FIGS. 1A and 1B, fenestration unit 10 includes a screen assembly 100. The screen assembly 100 includes a screen 102 (see FIG. 1B) that is operable to extend across an opening 11 (see, e.g., FIG. 1C) in the fenestration unit 10 formed when, for example, the first panel 14 is opened on the fenestration unit 10. The screen assembly 100 is independently actuatable to be deployed regardless of the position of the first panel 14 or second panel 16 such that the screen assembly 100 may be deployed when the first panel 14 or second panel 16 is in the open position and/or closed position or may be in the undeployed state when the first panel 14 or second panel 16 is in the open position and/or closed position. The frame 12 may define a first portion or first pocket 50 within which the first panel 14 is engaged, a second portion or pocket 52 within which the second panel 16 is engaged, and a third portion or pocket 54 within which at least a portion of the screen assembly 100 is engaged. Referring to FIG. 1D, the pockets 50, 52, 54 define a position within which the first and second panels 14, 16 and the screen assembly 100 may be positioned within the fenestration unit 10. In some embodiments, at least two of the pockets 50, 52, 54 may be coextensive or positioned along the same plane. For example, the first pocket 50 and the second pocket 52 may be positioned within the same plane, with one end of the first pocket 50 being positioned adjacent to one end of the second pocket 52 (e.g., in a two-panel fenestration unit with a hinged panel and a fixed panel). In some embodiments, the pockets 50, 52, 54 may be provided such that they may include tracks (not shown) along which corresponding parts of the first panel 14 (e.g., in those embodiments in which the first panel 14 is a sliding panel), the second panel 16 (e.g., in those embodiments in which the second panel 16 is a sliding panel), and at least a portion of the screen assembly 100 can ride.

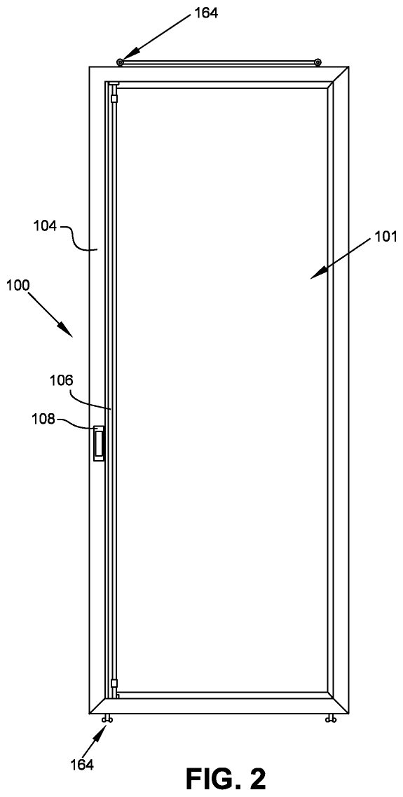

Referring to FIG. 2, the screen assembly 100 is illustrated independent of the fenestration unit 10. The screen assembly 100 includes the screen 102 (see FIG. 1B), a screen frame 104, and a control member 106. As illustrated in FIG. 2, the screen assembly 100 is positioned in the stowed configuration such that the screen 102 is not visible or exposed to the elements. The screen assembly 100 can be deployed to the deployed configuration in which the screen 102 extends across an opening 101 of the screen frame 104. For example, the screen assembly 100 including the screen 102 is operable to extend across the opening 11 of the fenestration unit 10 when the screen assembly 100 is positioned in a deployed configuration (see FIG. 1B) and operable to be positioned to allow ingress and egress through the opening 11 of the fenestration unit 10 when the screen assembly 100 is in a stowed configuration (see FIG. 1C). The screen 102 further includes a handle 108 that can be used to transition the screen assembly 100 between the deployed configuration and the stowed configuration.

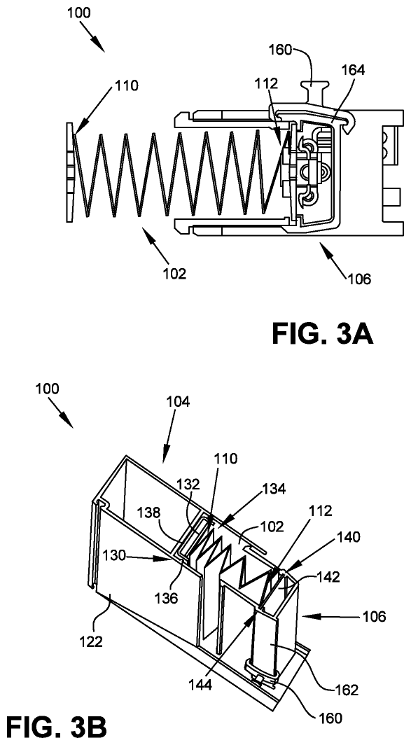

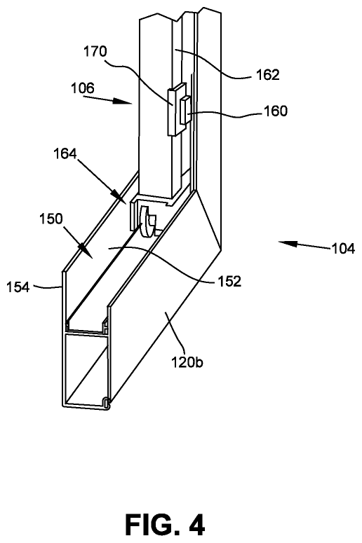

Referring to FIGS. 3A and 3B, a sectional top view and a sectional perspective view of a portion of the screen assembly 100 is shown. As shown, the screen 102 includes a first end 110 (e.g., first lateral end) and a second end 112 (e.g., second lateral end) opposite the first end 110. The screen 102 is coupled (either directly or indirectly) to the screen frame 104 at or near the first end 110 and is coupled (either directly or indirectly) to the control member 106 at or near the second end 112. The opening 11 of the fenestration unit 10 may be covered with the screen 102 when the screen assembly 100 is in the deployed configuration and the screen frame 104 is positioned such that the first end 110 of the screen 102 is at a first end of the opening 11 of the fenestration unit 10 and the control member 106 and the second end 112 of the screen 102 are at a second end of the opening 11 of the fenestration unit 10, which results in the screen 102 extending across the opening 11.

The screen frame 104 is operable to engage with and translate (e.g., slide) relative to the fenestration frame 12 (see FIGS. 1A and 1B). As the screen frame 104 slides relative to the fenestration frame 12, the screen assembly 100 is toggled between a deployed configuration and a stowed configuration (and partially deployed configurations therebetween). The screen 102 may be substantially flat when in the deployed configuration (see FIG. 1B) and may be folded into pleats when in the stowed configuration (See FIGS. 3A and 3B). In various examples, the screen 102 is orientated such that the pleats are vertical pleats (i.e., the folds are oriented vertically). This directionality is relative, and by rotating the assembly 90 degrees, including the direction of opening 11 (e.g., in a window unit that slides vertically to open and close), the pleats may be horizontal pleats (e.g., the folds are oriented horizontally). Regardless, as shown, the screen assembly 100 is operable to deploy and stow horizontally. This may be advantageous as the number of components may be reduced because engagement or retraction systems are not necessitated by a horizontally-deploying pleated screen.

Referring again to FIGS. 1B and 1D, the screen frame 104 is operable to engage with the fenestration frame 12 in one of the pockets (e.g., the third pocket 54) of the fenestration frame 12. As shown, the screen frame 104 is operable to slide relative to the fenestration frame 12 along the third pocket 54. As part of this engagement between the screen frame 104 and the third pocket 54, the screen frame 104 includes a pocket engaging member 120, or pocket engaging members 120a, 120b (see e.g., FIGS. 1B-1C), and a screen engaging member 122. The one or more pocket engaging member(s) 120 are operable to be positioned slidably within the third pocket 54 and screen engaging member 122 is operable to engage with and retain at least a portion of the screen 102 (e.g., second end 112 of the screen 102). As the screen frame 104 is translated along the third pocket 54, the screen 102 is transitioned between a deployed configuration and a stowed configuration. When the screen 102 is positioned in the fully deployed configuration, the screen engaging member(s) 122 is (are) positioned abutting one of the jambs 22 of the fenestration frame 12 (see FIG. 1B). This allows the screen 102 to extend across the lateral portion of the opening 11 of the fenestration unit 10. The screen 102 extends substantially between the head 18 and the sill 20 of the fenestration frame 12 such that the screen assembly 100, when in the deployed configuration, substantially extends across the entirety of the opening 11 to limit ingress and egress (including limiting ingress and egress of insects and other small creatures and objects), while still allowing air flow through the fenestration unit 10.

The screen frame 104 may be provided in various arrangements and the arrangement described and shown herein is an example of one of those arrangements. For example, the pocket engaging member 120 may include an upper pocket engaging member 120a and a lower pocket engaging member 120b (i.e., an upper rail and a lower rail) and the screen engaging member 122 (e.g., a first stile) may define a vertical support that is positioned near a lateral end 126 of the upper and lower pocket engaging member 120a, 120b (see, e.g., FIGS. 1A-1C). The screen frame 104 also may include at least one other screen engaging member 123 (e.g., a second stile) (see, e.g., FIGS. 1A and 1C) that is coupled to an opposing lateral end 128 of the upper and lower pocket engaging members 120a, 120b. Thus, the screen frame 104 may include a substantially rectangular profile that is similar to the profile of a typical frame of a flat screen panel (e.g., with an upper rail, a lower rail, and two stiles).

Referring to FIG. 3B, in some embodiments, the screen engaging member 122 may include a receiver 130 which engages (either directly or indirectly) with the screen 102 (e.g., at the first end 110 of the screen 102). For example, the first end 110 of the screen 102 may include or be coupled to an interface member 132 that is operable to be received and retained by the receiver 130 of the screen engaging member 122. Thus, when the screen frame 104 is toggled between a deployed and a stowed configuration, the first end 110 of the screen 102 moves with the screen engaging member 122. In some embodiments, the interface member 132 may be mountable to the screen engaging member 122 such that the interface member 132 and/or first end 110 of the screen 102 is selectively removeable from the screen engaging member 122 of the screen frame 104. In other embodiments, the interface member 132 and/or first end 110 of the screen 102 is permanently coupled to the screen engaging member 122. The interface member 132 may be coupled to the screen 102 in a variety of ways, including but not limited to adhesives, mechanical fasteners, bonding, sewing, and so forth. The interface member 132 may also be coupled to the screen engaging member 122 in a variety of ways, including but not limited to adhesives, mechanical fasteners, bonding, friction fit, cooperative channels and retaining structures (e.g., see protrusions 136), and so forth. It is also understood that any number of intermediate structures or intermediate members 138 may be implemented between the screen 102 and the screen engaging member 122 (e.g., the interface member 132, intermediate member 138 coupling the interface member 132 to the screen engaging member, and so forth). In some embodiments, the screen engaging member 122 defines a channel or recess 134 within which the receiver 130 is positioned. The channel or recess 134 is operable to conceal the interface member 132 and at least a portion of the screen 102. In some embodiments, at least a portion of the control member 106 may also be positioned within the channel or recess 134 of the screen engaging member 122 when the screen assembly is in the stowed configuration.

When the screen frame 104 is positioned in both the deployed configuration (see FIG. 1B) and the stowed configuration (See FIG. 1A), the screen frame 104 is substantially positioned within a profile of the frame 12, the first panel 14, and/or the second panel 16 such that when viewing the fenestration unit 10 from the interior or exterior sides, the screen frame 104 does not obstruct portions of the glazing 30, 38. In other words, the screen frame 104 is hidden from view, or substantially hidden from view. Any portion of the screen frame 104 may optionally include brushes that are operable to engage with the frame 12, the first panel 14, and/or the second panel 16 to limit ingress or egress of insects around components of the screen frame 104. It is understood that the brushes may also be positioned on the frame 12, the first panel 14, and/or the second panel 16 to engage the screen frame 104.

Referring still to FIG. 3B, in some embodiments, the control member 106 may include a receiver 140 which engages (either directly or indirectly) with the screen 102 (e.g., at the second end 112 of the screen 102). For example, the second end 112 of the screen 102 may include or be coupled to an interface member 142 that is operable to be received and retained by the receiver 140 of the control member 106. Thus, when the screen frame 104 is toggled between a deployed and a stowed configuration, the second end 112 of the screen 102 is retained by the control member 106 as the screen 102 transitions between a deployed (e.g., substantially flat, or flatter condition) and a stowed (e.g., pleated, or more pleated condition) configuration. In some embodiments, the interface member 142 may be mountable to the control member 106 such that the interface member 142 and/or second end 112 of the screen 102 is/are selectively removeable from the control member 106. In other embodiments, the interface member 142 and/or second end 112 of the screen 102 is/are permanently coupled to the control member 106. The interface member 142 may be coupled to the screen 102 in a variety of ways, including but not limited to adhesives, mechanical fasteners, bonding, sewing, and so forth. The interface member 142 may also be coupled to the control member 106 in a variety of ways, including but not limited to adhesives, mechanical fasteners, bonding, friction fit, cooperative channels and retaining structures, and so forth. In some embodiments, the control member 106 defines a channel or recess 144 within which the interface member 142 is positioned. The channel or recess 144 is operable to conceal the interface member 142 and at least a portion of the screen 102.

When the screen assembly 100 is in the stowed configuration, the screen frame 104 and the control member 106 cooperate to fully conceal the screen 102. By concealing the screen 102 when in the stowed configuration, the screen 102 does not obscure the ability to view through the glazing 30, 38. Furthermore, the screen 102 is protected from the elements when in the stowed configuration. This allows the screen 102 to be maintained in a cleaner state as well as reduce build-up on the screen 102 (e.g., dust pollen, debris, etc.). This allows the visibility and airflow through the screen 102 to be optimized when the screen assembly 100 is in the deployed configuration.

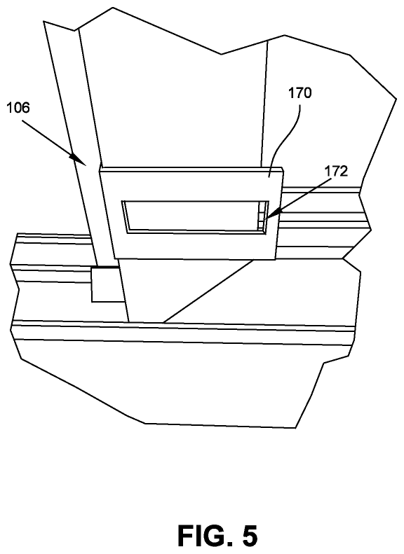

Referring to FIG. 4, the control member 106 is operable to linearly translate (e.g., slide, roll, etc.) relative to at least a portion of the screen frame 104. As the control member 106 translates relative to the screen frame 104, the screen 102 is able to be transitioned between a deployed configuration and a stowed configuration. In some embodiments, the control member 106 slides along channels 150 defined by the screen frame 104. For example, in some embodiments, the upper and lower pocket engaging members 120a, 120b (e.g., upper rail and lower rail) define channels 150 within which the control member 106 is operable to ride. The channels 150 are open toward a middle of the screen frame 104 which allows longitudinal ends of the control member 106 to be positioned within the channels 150 and translate along the channels 150. The channels 150 are defined between an interior wall 152 and an exterior wall 154 that extend toward the center of the screen frame 104. The interior and exterior walls 152, 154 can provide several functionalities, including but not limited to, limiting movement of the control member 106 such that the control member 106 stays within predefined directions or planes, providing structural support to the screen 102 when the screen 102 is in a deployed configuration, providing containment of edges of the screen 102 which reduces the risk of dislodging the screen 102 (e.g., dislodgement from wind or pets) from the channel 150 during use, and providing additional boundaries to reduce instances of pests or debris circumnavigating the screen 102.

The control member 106 further includes a deployment member 160. The deployment member 160 is operable to limit movement of the control member 106 relative to the fenestration frame 12 when the screen assembly 100 is toggled between the deployed configuration and the stowed configuration. The deployment member 160 may be provided to contact a variety of structures on the fenestration unit 10 in order to provide the mechanical interference to allow the control member 106 to translate relative to the screen frame 104 when the screen frame 104 is being moved between the deployed configuration and the stowed configuration. For example, in some embodiments, the deployment member 160 is operable to contact one of the first and second panels 14, 16, which provide mechanical interference to limit further movement of the control member 106 relative to the first or second panel 14, 16. This example is not meant to be limiting, and it is understood that the deployment member 160 can interface with a variety of structures, including, but not limited to, the fenestration frame 12, support members (not shown), first and second panels 14, 16, mullions (not shown), casings (not shown), side lights (not shown), and so forth. Thus, the control member 106 is operable to remain positioned proximate the corresponding structure which is contacted by the deployment member 160 (e.g., the second panel 16) when the screen fame 104 is translated relative to the fenestration frame 12.

In some embodiments, the control member 106 defines a track 162 along which the deployment member 160 is operable to travel. The track 162 is positioned over at least a portion of a longitudinal length of the control member 106. In the embodiments shown herein, this allows the deployment member 160 to be repositionable vertically along the control member 106. This allows for the deployment member 160 to be selectively positioned for engagement as described herein or positioned such that the deployment member 160 can remained positioned on the screen assembly 100 but is disengaged from the features of the fenestration unit 10 that result in deployment of the screen 102 within the screen assembly 100.

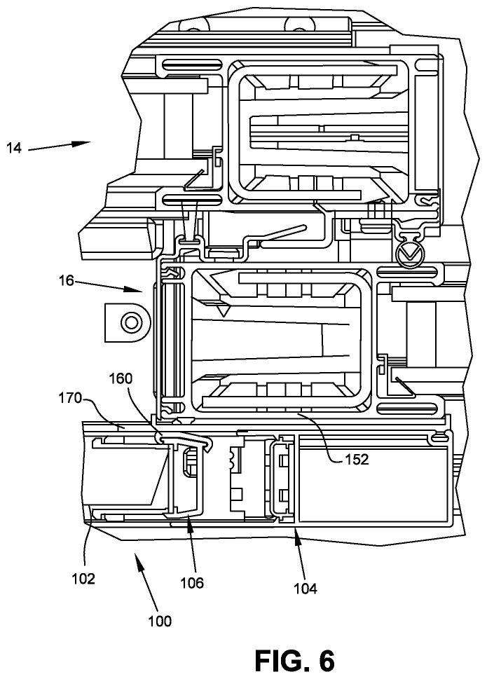

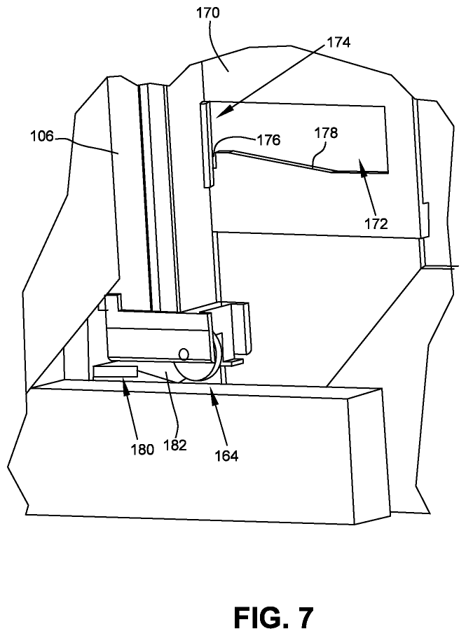

Referring to FIGS. 4-6, in some embodiments, the screen assembly 100 is further provided with brackets 170 that can be coupled (e.g., attached, fastened, adhered, etc.) to the various components of the fenestration unit 10 to provide mechanical interference to the deployment member 160. The bracket 170 can also limit or prevent wear or damage to other components of the fenestration unit 10 caused by repeated contact with the deployment member 160. FIG. 6 illustrates an embodiment in which the bracket 170 is fastened to the second panel 16. The deployment member 160 extends from the control member 106. As the screen frame 104 slides away from the second panel 106, the deployment member 160 contacts the bracket 170 which provides mechanical interference and limits movement of the control member 106 away from the second panel 16. This allows for the screen 102 to be deployed as the control member 106 translates along at least a portion of the screen frame 104.

The brackets 170 may be provided in various configurations and those shown and described are provided only as examples. In one embodiment, the bracket 170 is substantially flat such that it may be positioned between various components of the fenestration unit 10. The bracket 170 defines a channel 172 within which a portion of the deployment member 160 may extend. This allows the deployment member 160 to travel within the channel 172 until the deployment member 160 reaches the ends of the channel 172, at which point the deployment member 160 engages the bracket 170. When the deployment member 160 engages the bracket 170, the control member 106 is retained with the bracket 170, and the screen assembly 100 may be deployed. The channel 172, in some embodiments, may facilitate concealment of the control member 106 and screen 102 within the screen frame 104 while also allowing the screen assembly 100 to travel substantially along the length of the fenestration unit 10.

In some embodiments, the control member 106 includes a roller 164 (see, e.g., FIG. 4) which allows the control member 106 to smoothly translate along the channel 150 defined in the screen frame 104. The roller 164 is operable to ride along a predefined path (e.g., as defined by the channel 150) while the screen assembly 100 transitions between the deployed and stowed configurations. The roller 164 may be positioned at the top and at the bottom of the control member 106.

As the screen frame 104 is translated to the deployed configuration, the control member 106 moves relative to the screen frame 104 such that the control member 106 is positioned proximate the other screen engaging member 123 (e.g., the second stile). In some embodiments, the other screen engaging member 123 defines a recess (not shown) within which the control member 106 is at least partially positioned when the screen assembly 100 is in the deployed configuration. The control member 106 and/or the other screen engaging member 123 may include brushes (not shown) to limit ingress and egress through the screen frame 104 around the control member 106. When the screen assembly 100 is in the deployed configuration, the screen frame 104 substantially engages with the fenestration structure surrounding the opening 11 (e.g., the fenestration frame 12, second panel 16, etc.). Various brushes may be provided on any of the discussed structures to provide a more effective guard against pests or debris entering through an opening defined around the outer periphery of the screen frame 104. The screen 102 is stretched into a substantially flat, or more flat configuration (e.g., the pleats are minimized) and covers the opening defined by the screen frame 104. Thus, the screen assembly 100 substantially limits ingress and egress of pests and/or debris through the opening 11 defined by the fenestration unit 10 when the screen assembly 100 is in the deployed configuration. When the screen assembly 100 is in the stowed configuration, the screen 102 is substantially hidden within the screen frame 104, thus allowing an unobscured view through the screen frame 104 (e.g., when the screen assembly 100 is positioned proximate the second panel 16).

The screen assembly 100 can be provided with the fenestration unit 10 or can be provided as a retrofit kit that can be installed on a variety of fenestration units.

A method of assembling the screen assembly 100 on the fenestration unit 10 includes positioning the screen assembly 100 on the frame 12 of the fenestration unit 10. The screen assembly 100 may be positioned within a track of at least one of the pockets 50, 52, 54 (e.g., as shown in FIG. 4). The screen assembly 100 includes the screen 102 (e.g., the pleated screen) operable to extend across the opening 11 of the fenestration unit 12 when the screen assembly 100 is positioned in the deployed configuration and operable to allow ingress and egress through the opening 11 of the fenestration unit 10 when the screen assembly 100 is in a stowed configuration. The screen 102 includes a first lateral end 110 and a second lateral end 112 opposite to the first lateral end 110 (e.g., as shown in FIGS. 3A-3B), and the screen 102 is substantially flatter when the screen assembly 100 is in the deployed configuration and is folded into pleats when the screen assembly 100 is in the stowed configuration. The screen assembly 100 includes the screen frame 104 that is coupled to the first lateral end 100 of the screen 102. During assembly of the screen assembly 100 on the fenestration unit 10, the screen frame 104 is engaged with the fenestration frame 12 such that the screen assembly 100 is operable to translate relative to the fenestration frame 12 and across the opening 11 of the fenestration unit 10. The screen assembly 100 further includes the control member 106 coupled to the second lateral end 112 of the screen 102. The control member 106 may be slidingly engaged with the screen frame 104 and the control member 106 may be engaged with a portion of the second panel 16. The screen assembly 100 may further include the bracket 170, and assembling the screen assembly 100 on the fenestration unit 10 may further include positioning the bracket 170 on the second panel 16 such that the control member 106 engages with the bracket 170 of the second panel 16 during operation (e.g., when the screen assembly 100 is transitioned between the stowed and deployed configurations).

The screen assembly 100 may be operated after assembly onto the fenestration unit 10 in order to deploy and stow the screen assembly 100. The screen frame 104 is translated (e.g., slid or rolled) along the fenestration frame 12 (e.g., along the track of at least one of the pockets 50, 52, 54 as shown in FIG. 4). As the screen frame 104 is translated, the control member 106 is retained relative to the second panel 16. As the control member 106 is retained and the screen frame 104 continues to translate along the fenestration frame 12, the screen 102 is either deployed or stowed. The control member 106 may include the deployment member 160 that interfaces with the portion of the second panel 16 (e.g., the bracket 170 positioned on the second panel 16).

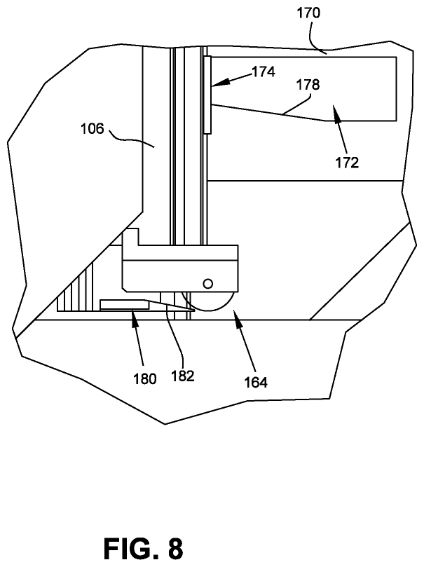

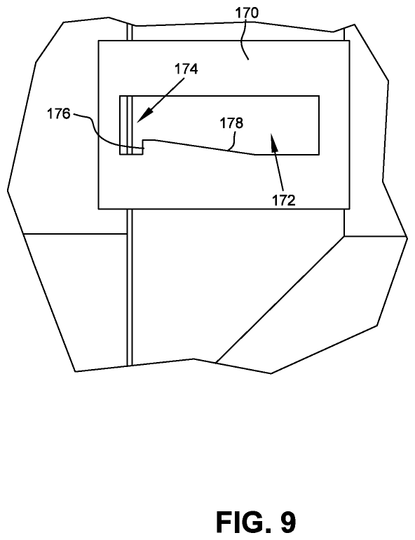

Referring to FIGS. 7-9, in some embodiments, the bracket 170 may be provided with the channel 172 that is capable of retaining the control member 106 at a predefined position during transition between the stowed and deployed configurations. For example, the channel 172 may define a pocket 174 within which the deployment member 160 is retained during the transition between the stowed and deployed configurations of the screen assembly 100. The pocket 174 is defined by a side wall 176, which may be positioned lower relative to a remainder of the channel 172 and provide mechanical interference against the deployment member 160 when the deployment member is positioned in the pocket 174. The channel 172 is also defined by a ramp portion 178 which facilitates movement of the deployment member 160 within the channel 172. The ramp portion 178 facilitates movement of the control member 106 into concealed position within at least one of the screen engaging members 122, 123 (e.g., the first and second stiles 28). This facilitates movement of the control member 106 within the screen frame 104, which may provide tactile feedback in the form of a tight haptic feel, to indicate the control member 106 is retained at a specific, or desired, position within the channel 172 (e.g., the deployment member 160 positioned within the channel 172) during the transition of the screen assembly 100 between the stowed and deployed configurations.

Referring to FIGS. 7 and 8, in order to disengage the deployment member 160 from the pocket 174, a ramp or wedge 180 may be provided within channel 150 of screen frame 104 (e.g., as shown in FIG. 4). The ramp or wedge 180 may be provided such that as the control member 106 contacts the wedge 180, the control bar member is translated (e.g., shifted upward as a whole) such that the deployment member 160 is translated out of the pocket 174. Referring to FIGS. 7-8, as the screen assembly 100 is transitioned from the deployed configuration toward the stowed configuration, the roller 164 of the control member 106 comes in contact with the wedge 180. As the roller 164 rolls up a ramped surface 182 of the wedge 180, the control member 106 is lifted or translated upward relative to the screen frame 104. This allows the deployment member 160 to be disengaged from the pocket 174 and raised out from and away from side wall 176 and allows the deployment member 160 to further travel within the channel 172 of the bracket 170 away from the pocket 174. This facilitates the ability of the screen frame 104 to be translated all the way toward the jamb 22 of the frame 12 of the fenestration unit 10. This also allows the screen frame 104 to be positioned within the profile of the second panel 16 so as to reduce the profile of the portions of the fenestration unit 10 that may obstruct the view of the user.

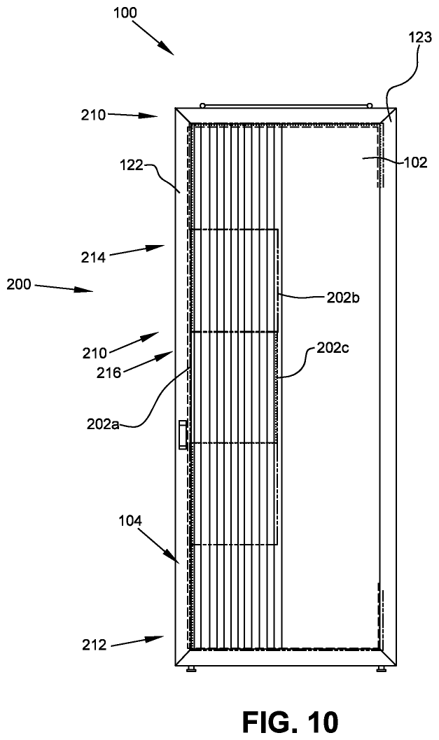

Referring to FIG. 10, a cord routing system 200 for the screen assembly 100 is provided. The cord routing system 200 helps facilitate controlled deployment and storage of the screen 102 during use as well as stability to the screen 102 during use. The cord routing system 200 may include at least one, two, or three cords 202 that are implemented for stabilizing the screen 102. In one embodiment, the cord routing system 200 includes a first cord 202a, a second cord 202b, and a third cord 202c. Each of the cords 202 may be fixed to the screen frame 104 at the same position at different positions. As shown in FIG. 10, the cords 200 are fixed at a similar position on the screen engaging member 123 (e.g., the second stile) The first cord 202a runs approximately straight between and along the screen engaging members, 122, 123 (e.g., the first and second stiles). The second cord 202b includes a pattern in which the second cord crisscrosses across the screen 102 and between inner and outer portions of the screen 102 to provide stability to the control member 106. The second cord 202b runs through the screen 102 at least one position 214 between the upper end 210 and lower end 212 of the screen 102. The third cord 202c is operable to provide center support for the screen 102 and runs through the screen 102 at a position 216 between the upper and lower ends 210, 212 of the screen 102 and, in some embodiments, the third cord 202c runs through the screen 102 at a position between at least an outer portion of position 214 through which the second cord 202b runs through the screen 102. In some embodiments, the third cord 202c may run through the screen 102 at a position similar to at least an inner portion of position 214 through which the second cord 202b runs through the screen 102. The cord routing system 200 may include various pulleys, wheels, and components to facilitate redirection and limit wear of the cords 202 during use.

The inventive concepts hereby addressed have been described above both generically and with regard to specific examples. It will be apparent to those skilled in the art that various modifications and variations can be made in the examples without departing from the scope of the disclosure. Likewise, the various components discussed in the examples are combinable. Thus, it is intended that the examples be viewed collectively, as a whole, as also intimating various modifications and variations of those specific examples.

What is claimed is:

1. A screen assembly for a fenestration unit having a fenestration frame, a first panel, and a second panel, the first panel being operable to selectively allow and limit ingress and egress through an opening defined by the fenestration unit, the screen assembly comprising:
a pleated screen operable to extend across the opening of the fenestration unit when the screen assembly is positioned in a deployed configuration and operable to be positioned to allow ingress and egress through the opening of the fenestration unit when the screen assembly is in a stowed configuration, the pleated screen including a first lateral end and a second lateral end opposite the first lateral end, wherein the pleated screen is substantially flatter when the screen assembly is in the deployed configuration and is folded into pleats when the screen assembly is in the stowed configuration;
a screen frame coupled to the first lateral end of the pleated screen, the screen frame operable to be engaged with and translate relative to the fenestration frame and across the opening of the fenestration unit; and
a control member coupled to the second lateral end of the pleated screen, the control member slidingly engaged with the screen frame.

2. The screen assembly of claim 1, wherein the screen frame is operable to slide laterally within the frame of the fenestration unit.

3. The screen assembly of claim 1, wherein the screen frame includes an upper rail, a lower rail, a first stile extending between the upper rail and a lower rail at a first lateral end of the upper and lower rails, and a second stile extending between the upper rail and the lower rail at a second lateral end of the upper and lower rails.

4. The screen assembly of claim 3, wherein the first lateral end of the screen is coupled to the first stile.

5. The screen assembly of claim 3, wherein each of the upper rail, lower rail, first stile, and second stile including channels within which an outer perimeter of the pleated screen is positioned when the screen assembly is in the deployed configuration.

6. The screen assembly of claim 3, wherein the first stile includes a channel within which the pleated screen is at least partially concealed when the screen assembly is in a stowed configuration.

7. The screen assembly of claim 6, wherein the control member is operable to be positioned at least partially within the channel of the first stile when the screen assembly is in a stowed configuration.

8. The screen assembly of claim 1, wherein the pleated screen includes vertical pleats such that the pleated screen deploys in a horizontal direction.

9. The screen assembly of claim 1, wherein the pleated screen is operable to be concealed by the screen frame and the control member when the screen assembly is in the stowed configuration such that the pleated screen is not visible from an interior side or an exterior side of the fenestration unit.

10. The screen assembly of claim 1, wherein the control member is movable relative to the screen frame.

11. The screen assembly of claim 1, wherein the control member includes a deployment member operable to engage with a corresponding feature of the fenestration unit, wherein the deployment member restricts movement of the control member relative to the fenestration unit when the screen frame is translated relative to the fenestration unit.

12. The screen assembly of claim 1, wherein the screen frame includes a channel along which the control member is operable to translate relative to the screen frame.

13. The screen assembly of claim 12, wherein the control member includes a roller operable to roll along at least a portion of the channel of the screen frame.

14. The screen assembly of claim 1, wherein the screen assembly is a retrofit kit.

15. A fenestration unit, comprising:
a fenestration frame including a head having a first lateral end and a second lateral end, a sill having a first lateral end and a second lateral end, a first jamb extending between the header and the sill at the first lateral sides of the header and sill, and a second jamb extending between the header and sill at the second lateral sides of the head and sill;
a first panel coupled to the fenestration frame, the first panel being operable to selectively allow and limit ingress and egress through an opening defined by the fenestration unit;
a second panel coupled to the fenestration frame; and
a screen assembly operable to be transitioned between a deployed configuration to limit ingress and egress through the fenestration unit while allowing air to flow through the opening of the fenestration unit when the first panel is in an open configuration and a stowed configuration to allow ingress and egress through the opening of the fenestration unit when the second panel is in the open configuration, wherein, when the screen assembly is positioned in the stowed configuration, visibility through the second panel is not obscured, the screen assembly including:
a pleated screen operable to extend across the opening of the fenestration unit when the screen assembly is positioned in a deployed configuration and operable to be positioned to allow ingress and egress through the opening of the fenestration unit when the screen assembly is in a stowed configuration, the pleated screen including a first lateral end and a second lateral end opposite the first lateral end, wherein the pleated screen is substantially flatter when the screen assembly is in the deployed configuration and is folded into pleats when in the screen assembly is in the stowed configuration;
a screen frame coupled to the first lateral end of the pleated screen, the screen frame slidingly coupled to the fenestration frame and operable to translate relative to along at least a portion of the fenestration frame; and
a control member coupled to the second lateral end of the pleated screen, the control member operable to translate relative to the screen assembly and to remain positioned proximate the second panel when the screen fame is translated relative to the fenestration frame.

16. The fenestration unit of claim 15, wherein the screen frame includes an upper rail, a lower rail, a first stile extending between the upper rail and a lower rail at a first lateral end of the upper and lower rails, and a second stile extending between the upper rail and the lower rail at a second lateral end of the upper and lower rails, wherein the first stile defines a first channel within which a portion of the pleated screen is housed when the screen assembly is in the stowed configuration.

17. The fenestration unit of claim 16, wherein the second stile defines a second channel, and wherein the control member is operable to be substantially contained within the second channel of the second stile when the screen assembly is in the deployed configuration.

18. The fenestration unit of claim 16, wherein the pleated screen includes a first longitudinal end and a second longitudinal end, wherein the upper rail of the screen frame includes a third channel within which the first longitudinal end of the pleated screen is positioned, and the lower rail of the screen frame includes a fourth channel within which the second longitudinal end of the pleated screen is positioned.

19. The fenestration unit of claim 15, wherein the pleated screen includes vertical pleats such that the pleated screen deploys in a horizontal direction.

20. The screen assembly of claim 15, wherein the pleated screen is operable to be concealed by the sliding member and the control member when the screen assembly is in the stowed configuration such that the pleated screen is not visible from an interior side or an exterior side of the fenestration unit.

21. The screen assembly of claim 15, further comprising a ramp positioned on the screen frame and operable to be contacted by the control bar to translate the control bar upward.

22. The screen assembly of claim 21, wherein the ramp is operable to translate a deployment member of the control bar out of a channel of a bracket to disengage the deployment member from the channel of the bracket.
